(19) United States
(12) Patent Application Publication
(10) Pub. No.: US 2016/0079685 A1
(43) Pub. Date: Mar. 17, 2016

(54) Method of Cold Joining Mineral Insulated Cables

(71) Applicant: Pentair Thermal Management LLC, Menlo Park, CA (US)

(72) Inventors: Scott M. Finlayson, Belleville (CA); Lawrence J. White, Newark (CA)

(21) Appl. No.: 14/489,286

(22) Filed: Sep. 17, 2014

(51) Int. Cl. H01R 4/20; H01R 43/048

(52) U.S. Cl. CPC H01R 4/20; H01R 43/048

(57) ABSTRACT

A method of cold joining a first cable and a second cable may include providing a connector having both right hand and left hand threads. The first cable may have a right hand threads on its core, while the second cable may have left hand threads along its core. The first and second cables may be simultaneously connected to the first and second cables to the connector by rotating the connector. The connector may then be crimped to permanently, or at least semi-permanently retain the first and second cores within the connector.

### RELATED APPLICATIONS

Not Applicable

### BACKGROUND

Piping systems are often used to transport a liquid and/or gas product, such as a petroleum product, over large distances, such as from an extraction point to a processing facility. If the extraction location and/or the processing facility are located in a cold weather environment, it may be necessary to provide a heating element, or heat trace, to maintain the pipe at a desired temperature to prevent the fluid product from freezing or, in temperature sensitive operations, to maintain a temperature that allows for an efficient flow of the fluid product.

The heating element may be a mineral-insulated electric heating cable, or MI cable. A MI cable is a variety of electrical cable having one or more conductor cores, insulated by an inorganic material, and sheathed by a metal material. Additionally, a jacket may be provided over the sheath for use in corrosive environments.

MI cables can be attached serially to each other, for lengthening a heat trace or for repairing a cable, by splicing the cables together. Splicing includes splicing the conductors and then enclosing the spliced location, all of which steps are typically done with soldering, brazing, or welding, or a combination of such high-heat techniques. In certain work locations where MI cables are used, however, it is hazardous or prohibited to use torches, flames, or other sources of high heat. Therefore, during installation or repair a “cold splice” technique must be used to avoid having to completely remove the cable from the area in order to perform the splice. Current cold splice techniques involve using a connector to crimp the ends of two cables together. One disadvantage of crimping alone is that the crimped cables may not be securely connected together. This may result in the two cable sections becoming disconnected over time, such as through tension in the cable. Additionally, an improperly connected MI cable can result in an unfavorable increase of electrical resistance at the connection. Thus, there is a need for an improved cold splicing technique for securely connecting two MI cable sections together.

### SUMMARY

According to one aspect of the disclosure, a method of cold joining a first cable having a first core and a second cable having a second core is disclosed. The method includes forming threads into the first core, with the threads having a first direction, and forming threads into the second core, with the threads having a second direction. The first core may be at least partially threaded into a connector having a first set of threads and a second set of threads. The connector may be at least partially threaded onto the second core.

According to a second aspect of the disclosure, a connector for cold joining two lengths of cable has a connector body having a first end section, a second end section, and a center section. A bore may extend axially through the connector body. The bore may have a first set of threads extending from the first end section towards the center section and a second set of threads extending from the second end section towards the center section. One of the first and the second set of threads may be a right hand threading and the other may be a left hand threading.

### DESCRIPTION OF THE DRAWINGS

FIG. 1 is a perspective view of a section of cable.

FIG. 2 is an exploded view of an example scoring tool.

FIG. 3 is a perspective view of the example scoring tool of FIG. 2 attached to the cable of FIG. 1.

FIG. 4 is a perspective view of the cable of FIG. 1 with a portion of the jacket scored.

FIG. 5 is a perspective view of the cable of FIG. 4 with a portion of the jacket removed.

FIG. 6 is an exploded view of an example facing tool.

FIG. 7 is a perspective view of the example facing tool of FIG. 6 attached to the cable of FIG. 5.

FIG. 8 is a perspective view of the cable of FIG. 7 with a portion of the cable core faced.

FIG. 9 is a perspective view of an example threading tool having a holder, die, and spacer plate for threading the core.

FIG. 10 is a perspective view of the example threading tool having the holder, die, and spacer plate of FIG. 9 attached to the cable of FIG. 8.

FIG. 11 is a perspective view of the cable of FIG. 10 with a portion of the core of the cable threaded.

FIG. 12 is a perspective view of a connector for splicing two cables of FIG. 11 together.

FIG. 13 is a cross-sectional view of the connector of FIG. 12, taken along line 13-13 of FIG. 12 for splicing cables together.

FIG. 14 is a perspective view of an example crimping tool.

FIG. 15 is a perspective view of the example crimping tool of FIG. 14 attached to the connector of FIG. 13.

FIG. 16 is a perspective view of the connector and cables of FIG. 13, with a crimped connector.

FIG. 17 is a cross-sectional view of the crimped connector taken along line 17-17 of FIG. 16.

### DETAILED DESCRIPTION

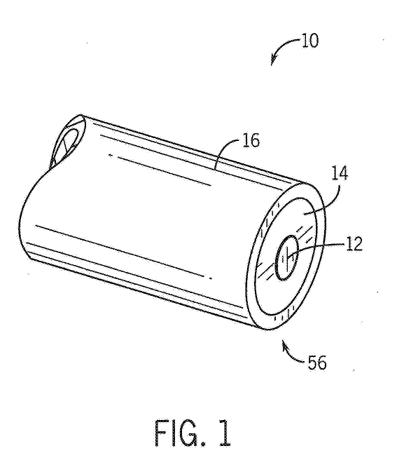

Referring to FIG. 1, a cable 10 may include one or more cores 12, a layer of insulation 14, and a sheath 16. In a corrosive environment, the cable 10 may further include a jacket (not shown). The core 12 may pass through the radial center of the cable 10 and extend in an axial direction. The core 12 may, for example, be a copper wire or other electrically conductive material. The insulation 14 may extend radially outward from the core 12 and may extend in an axial direction to substantially encompass the core 12. The insulation 14 may be an inorganic and nonconductive material, such as magnesium oxide powder or other flame resistant and nonconductive material. The sheath 16 may extend radially outward from the insulation 14 and may extend in an axial direction to substantially encompass the insulation 14. The sheath 16 may be made of a metal material, such as copper or steel, to provides protection and fire-retardation to the core 12 and the insulation 14. The sheath 16 may be covered by the jacket (not shown), which may be made of a polymer or other corrosion resistant material.

The core 12 of the cable 10 may be cold spliced with that of another cable using a scoring tool, a facing tool, a threading tool, a crimping tool, and a connector. The scoring tool, the facing tool, and the threading tool are used to prepare the two lengths of cable for splicing, and the connector and the crimping tool are used to at least semi-permanently connect the cores of the two lengths of cable together. Described below are specific instances of the scoring tool, the facing tool, the threading tool, and the crimping tool. However, it will be appreciated that the present splicing mechanisms and methods may be used after the cables are prepared with any suitable scoring tool, sizing tool, threading tool, and crimping tool.

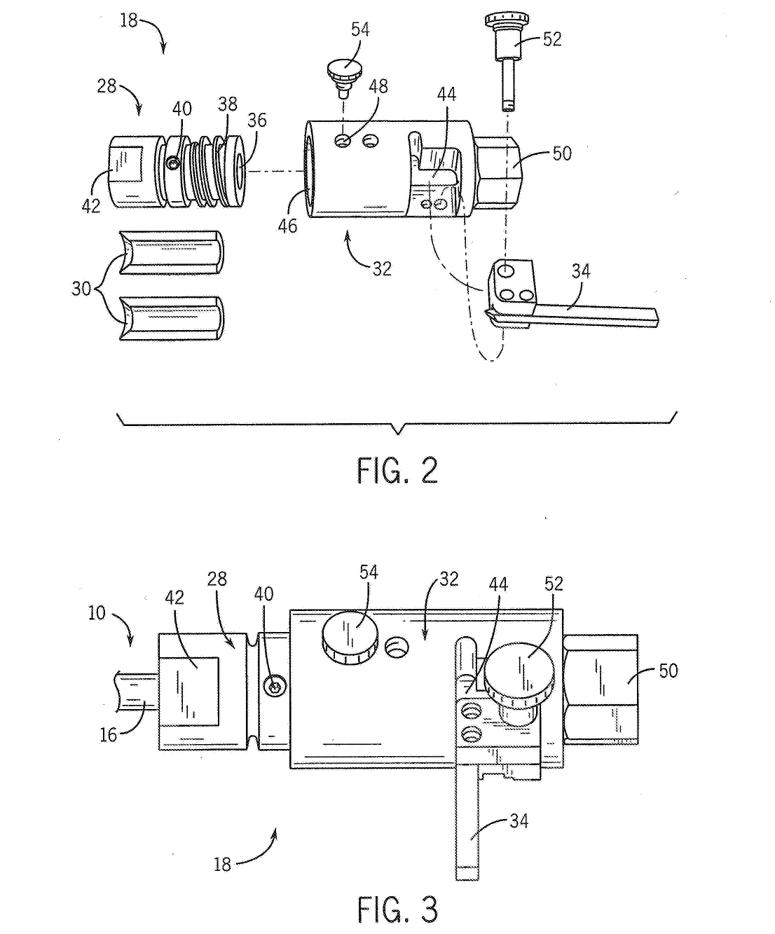

Referring to FIGS. 2 and 3, an example scoring tool 18 may include a base 28, a pair of clamping sleeves 30, a housing 32 rotatable with respect to the base 28, and a scoring blade assembly 34. The base 28 may include an axial bore 36, a groove 38 extending along a portion of the outer surface of the base 28 in a spiral manner, a mounting fastener 40, and a keyed end 42. The base 28 may also have an interior cutting ring (not shown) extending radially inward from the bore 36 and having a sharp edge for creating a circular score in the sheath 16.

The housing 32 may have an opening 44, a bore 46, a guide pin bore 48 extending radially through the housing 32, and a keyed end 50. The scoring blade assembly 34 may fit partially through the opening 44 and may attach to the housing 32 through a fastener 52. A guide pin 54 may pass through the guide pin bore 48 and may extend radially inward from the bore 46, and may be secured to the guide pin bore 48.

Referring to FIGS. 3-5, the example scoring tool 18 may be used to remove a portion of the sheath 16 to prepare a splicing section 49. The clamping sleeves 30 are placed on the cable 10 adjacent to the splicing section 49. The cable 10 is slid through the bore 36 of the base 28 until the clamping sleeves 30 are in the bore 36 and the cutting ring aligns with the opposite end of the splicing section 49 from an end 56 of the cable 10. The mounting fastener 40 may be driven radially inward against the clamping sleeves 30 to create a clamping force between the base 28, the clamping sleeves 30, and the cable 10. The clamping sleeves 30 may prevent the mounting fastener 40 from directly pressing into the cable 10, and may protect the cable 10 from damage due to the mounting fastener 40. Clamping the base 28 to the cable 10 will result in the cutting ring cutting a circumferential cut 60 into the sheath 16.

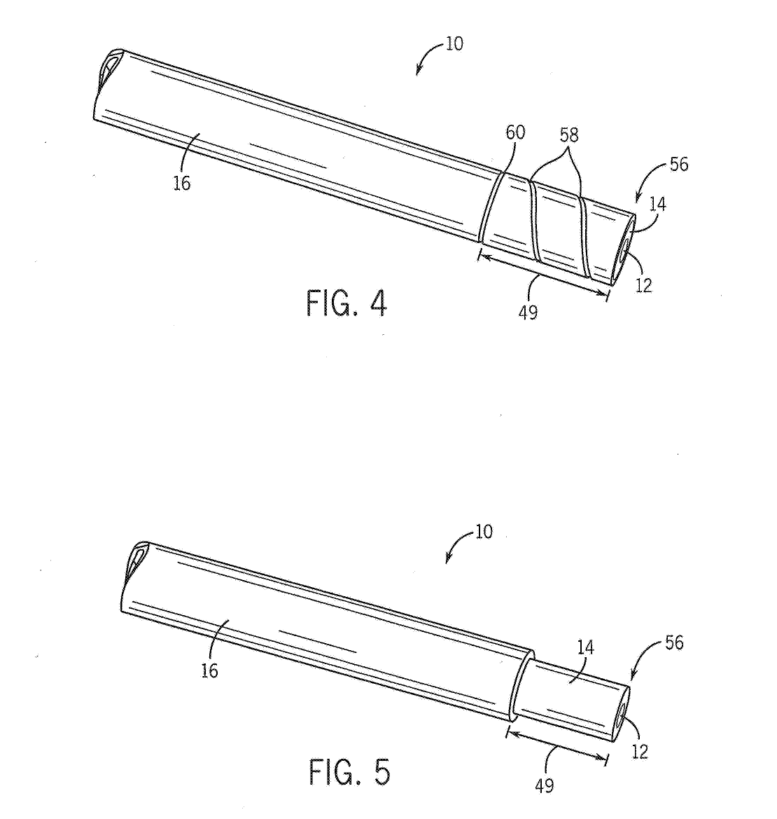

The housing 32 may then be placed over the cable 10 such that the guide pin 54 is located within the groove 38. A wrench, such as an adjustable wrench, may be coupled to the keyed end 42 of the base 28 to restrict rotation of the cable 10. Another wrench may be coupled to the keyed end 50 of the housing 32 to rotate the housing 32 relative to the cable 10 and the base 28. Rotating the housing 32 in a first direction pulls the housing 32 axially toward the keyed end 42 of the base 28, bringing the scoring blade assembly 34 in contact with the sheath 16. The scoring blade assembly 34 creates a spiral cut 58 in the sheath 16 as the housing rotates 32 and moves axially along the cable 10. After the sheath 16 has been scored with the spiral cut 58 and the circumferential cut 60, as shown in FIG. 4, the housing 32 may be rotated in a second direction, opposite the first direction, to decouple the housing 32 from the base 28. Alternatively, the guide pin 54 may be removed from the housing 32 to allow the housing 32 to slide off the base 28 without rotating. The base 28 may be removed from the cable 10 by removing the mounting fastener 40 and sliding the base 28 and off of the cable 10. The scored portion of the sheath 16 may then be removed to produce a stripped splicing section 49. The exposed insulation 14 in the splicing section 49 may be removed by hand or with a hand tool to expose the core 12.

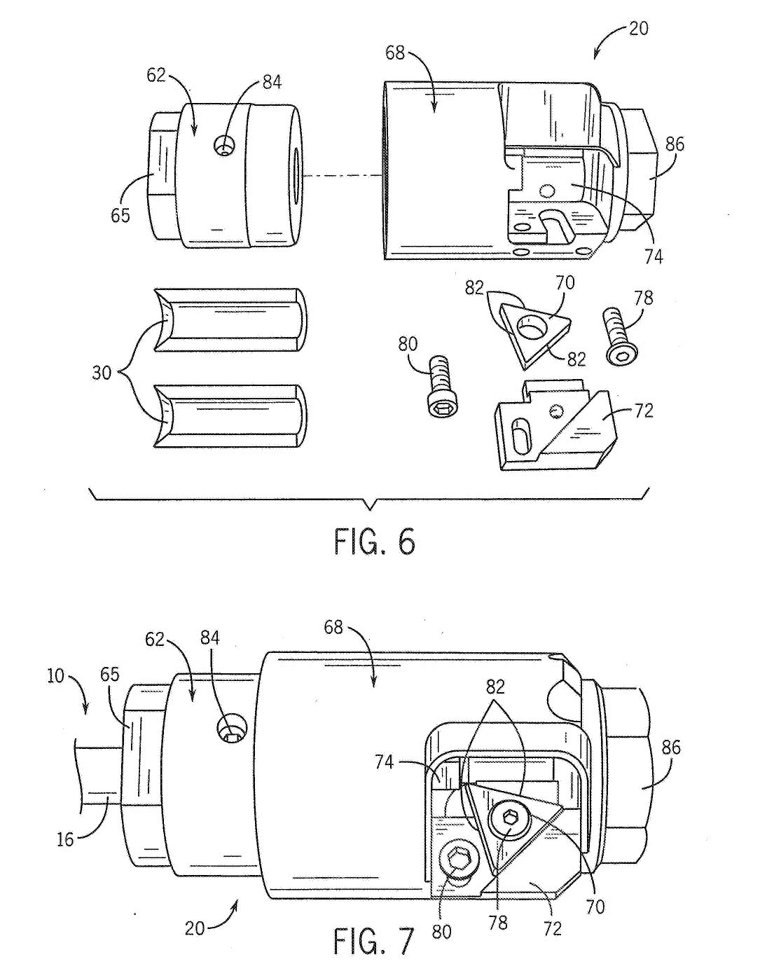

The outer surface of the core 12 can be roughened by the process of manufacturing the MI cable. It may be necessary or preferred to smooth the outer surface in a process referred to herein as “facing.” Referring to FIG. 6, an example facing tool 20 smoothes the outer surface of the core 12 within the splicing section 49. A blade 70 may be attached to a housing 68 by passing the blade 70 partially through an opening 74 in the housing 68, and then securing the blade 70 to the housing 68 using a blade holder 72 and fasteners 78 and 80. The opening 74 may extend from the outer surface of the housing 68 inward to the bore 76. The angle of the blade 70 relative to the bore 76 may be may determine the amount of material removed from the core 12. The blade 70 may be triangular shaped as shown in FIGS. 6 and 7, with each side 82 of the triangle being sharpened. If the blade 70 becomes dull during operation, a different sharpened side 82 may be brought into a cutting position.

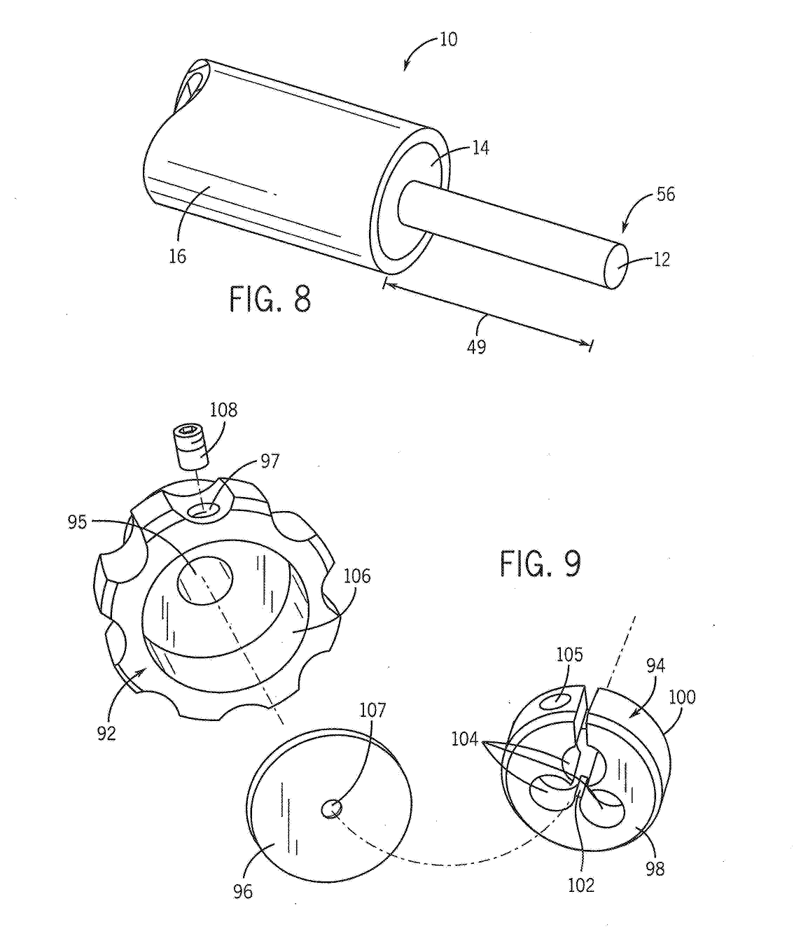

Referring to FIGS. 7 and 8, the facing tool 20 may be used to smooth the core 12 by removing a portion of the core 12 material to produce a smooth outer surface. The facing tool 20 may also partially reduce the diameter of the core 12 within the splicing section 49 if desired. The clamping sleeves 30 are again placed at the desired axial location on the cable 10, and the cable 10 and the clamping sleeves 30 are then slid into the bore 64 of the base 62. A mounting fastener 84 may be tightened against the clamping sleeves 30 to create a clamping force between the base 62, the clamping sleeves 30, and the cable 10. The housing 68 may be slid over the base 62 and cable 10 until the blade 70 abuts a portion of the insulation 14 and/or core 12, and a portion of the base 62 is within the bore 76 of the housing 68. A wrench may be coupled to the keyed end 65 of the base 62 to prevent the base 62 and the cable 10 from rotating. The housing 68 may then be rotated, such as by coupling a second wrench to the keyed end 86. Rotating the housing 86 causes the blade 70 to carve away a portion of the core 12 until the outer, exposed surface of the core 12 is substantially smooth. The housing 68 may then be slid off the base 62 and the cable 10. The base 62 is removed from the cable 10 by loosening the mounting fastener 84, sliding the base 62 off of the cable 10, and then removing the clamping sleeves 30.

Referring to FIG. 9, an example threading tool 22 can cut threads into the core 12 using a holder 92, a die 94, and a cylindrical blank 96. The holder 92 may have a radial bore 97 extending between a recessed area 106 and the outer surface of the holder 92, and may have an axial bore 95 extending entirely through the holder 92. The die 94 may have a first 98 and a second 100 axial end, a center bore 102, three off-center bores 104, and a radial bore 105. The center bore 102 is threaded to cut threads into the core 12. The off-center bores 104 allow the material cut from the core 12 to exit the threading tool 22. The blank 96 may have an axial bore 107, and may be inserted into the recessed area 106 of the holder 92 to act as an end stop during the threading process. The die 94 may be placed in the recessed area 106 until the die 94 abuts the blank 96. It will be appreciated that inserting the die 94 into the recessed area 106 first axial end 98 first may produce a right hand threading of the core 12, while inserting the die 94 into the recessed area 106 second axial end 100 first may produce a left-hand threading of the core 12. The die 94 and blank 96 may be secured to the holder 92 by passing a mounting fastener 108 through the radial bores 97 and 105. In an assembled state, the bores 95, 102, and 107 may be coaxial.

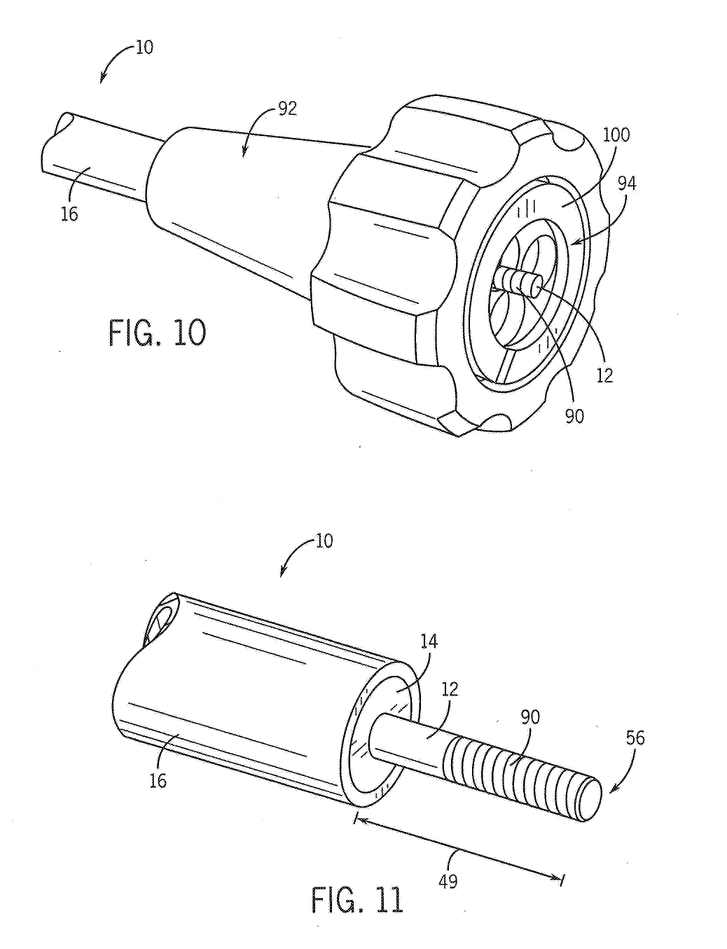

Referring to FIG. 10, to thread the core 12, the core 12 is fed through the bores 95, 96, and 107 to die 94. The die 94 may be rotated to pull the threading tool 22 along the core 12 and create the threads 90 in the core 12. The threading tool 22 may be removed from the core 12 by reversing the direction of rotation of the threading tool 22. The threading tool 22 may be disassembled by removing the fastener 108, and then removing the die 94 and the blank 96 from the holder 92. It will be appreciated that axially flipping the die 94 before mounting it within the holder 92, and subsequently rotating the holder 92 in the opposite direction will result in a different threading direction (i.e. left hand thread or right hand thread). Consequently, as it will be explained below, the second cable in the splicing operation should be threaded with an opposite threading to the first cable 10.

Referring to FIG. 13, the connector 26 may be a generally cylindrical piece of electrically conductive material, and may be the same material as the core 12 (e.g., copper). The connector 26 may have a first 110 and a second 112 end sections and a center section 116. The connector 26 may have an axial bore 114 extending entirely through the connector 26, which may be coaxial with the connector 26. The axial bore 114 receives the cores 12, 12b of the cables 10, 10b at the first end section 110 and second end section 112, respectively. Alternatively, two axial bores may pass partially through the connector 26, such that one extends inward from the first end section 110 towards the center section 116 of the connector 26, and the other axial bore extends inward from the second end section 112 towards the center section 116. The dual bores may be coaxial with one another and may intersect or not intersect within the connector 26. The axial bore 114, or bores, may be threaded along all or a portion of the bore length(s). For ease of installation, the axial bore 114 may have a right hand thread 118 extending from the first end section 110 towards the center section 116, and a left hand thread 120 extending from the second end section 112 towards the center section 116. The right hand thread 118 and the left hand thread 120 may touch in the center section 116, as illustrated in FIG. 13, or they may be axially spaced from one another in the center section 116.

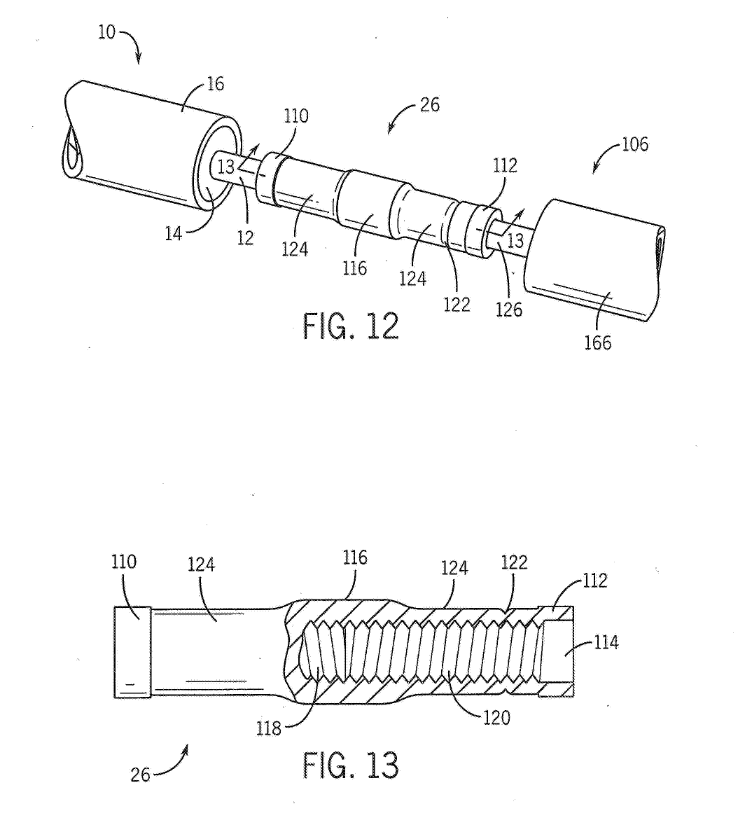

In some embodiments, such as that illustrated in FIGS. 12 and 13, the connector 26 may receive threaded cores 12, 12b that have the same outer diameter. Thus, the axial bore 114 may have a uniform diameter, or the dual bores may have the same diameter. In other embodiments, the cores 12, 12b may have different diameters. Correspondingly, the axial bore 114 may have a first diameter extending from the first end section 110 and a different second diameter extending from the second end section 112. Or, in the case of dual bores, the bores may have different diameters according to the size of the cores 12, 12b to be spliced together.

To identify which side is the right hand threading 118 and which side is the left hand threading 120, one side may have an identifier 122, shown as a circumferential indentation, in FIGS. 12 and 13. It will be appreciated that the identifier 122 may alternatively be a raised circumferential section, may be in the form of raised or indented writing, or may be any other suitable identifier.

The connector 26 may also have two crimping zones 124. One of the crimping zones 124 may be located between the first end section 110 and the center section 116 and another crimping zone 124, may be located between the second end section 112 and the center section 116. The end sections 110 and 112 have a radial thickness defined by the distance between the axial bore 114 and the outer surface of the end sections 110 and 112. Similarly the center section 116 has a radial thickness defined by the distance between the axial bore 114 and the outer surface of the center section 116. The end sections 110 and 112 and the center section 116 may have the same or different thicknesses. The crimping zones 124 also have a thickness defined by the radial distance between the axial bore 114 and the outer surface of the crimping zone 124. The crimping zones 124 may have an outer diameter that is smaller than the outer diameters of the end sections 110 and 112 and the center section 116. Consequent, the thickness of the crimping zones 124 is less than the thickness of the end sections 110 and 112 and the center section 116, and may encourage the crimping zones 124 to crush or crimp prior to the end sections 110 and 112 and the center section 116. By providing thicker end sections 110 and 112 and the center section 116, the connector 26 may be protected from being unintentionally crimped or crushed.

The connector 26 may attach two sections of cable 10 and 10b. By providing a cable 10 with right hand threading and a cable 10b with left hand threading, and providing a connector 26 having right hand threading and left hand threading, the connector 26 can function as a turnbuckle to make connection of the two cables 10 and 10b to the connector 26 simpler. For example, an operator may partially thread the cable 10 onto the right hand threads 118 by rotating the connector 26. The operator may then bring the cable 10b in contact with the connector 26 and may turn the connector 26 to begin threading the cable 10b with the left hand threads 120. Since, the two sides have opposite threading; turning the connector 26 will simultaneously thread or unthread both cables 10 and 10b. Whereas, a connector 26 having only right hand threads 118 or left hand threads 120 would require rotating at least one cable 10 or 10b to have both cables 10 and 10b connected to the connector 26. The threads 118 and 120 of the cores 12 and 12b and the connector 26 may be separated by a slight gap 142 prior to crimping. The gap 142 provides enough of a tolerance to allow the connector 26 to rotate relative to the cores 12 and 12b. Prior to crimping, the connector 26 can be adjusted to provide more core 12 and 12b length within the connector, or the connector 26 may be completely removed from the cores 12 and 12b.

After the cores 12 and 12b of the cables 10 and 10b are sufficiently connected to the connector 26 through threading, as shown in FIG, 12, the connector 26 may be crimped to prevent the cores 12 and 12b coming loose from the connector 26. Furthermore, crimping the mated threaded sections of the connector 26 and the cores 12 and 12b may reduce or eliminate the gap 142 making it very difficult or impossible to remove the cores 12 and 12b from the connector 26. Crimping, as described below, may be done using the crimping tool 24.

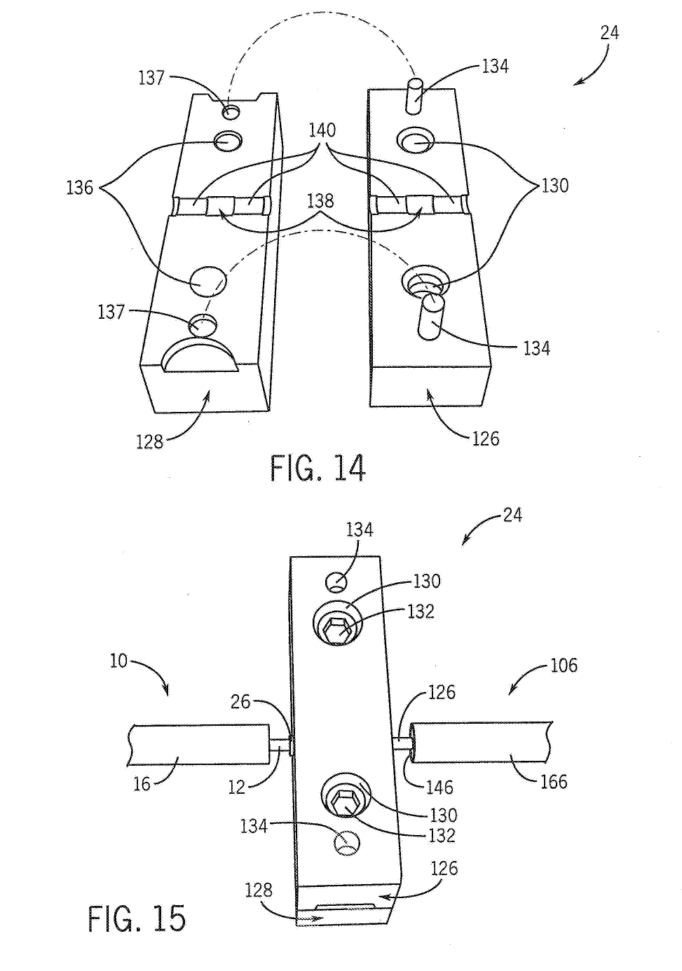

Referring to FIG. 14, an example crimping tool 24 may include a top plate 126 and a bottom plate 128. The top plate 126 may have two threaded bores 130 for each receiving a clamping fastener 132. The top plate 126 may also have two guide pins 134. The bottom plate 128 may similarly have two threaded bores 136 for receiving the clamping fasteners 132, and may have two holes 137 for receiving the guide pins 134. The top 126 and bottom 128 plates may each also have a mold indentation 138. The mold indentations 138 may be similar in shape to the connector 26, but may be slightly smaller in certain areas, such as the crimping zones 140 corresponding to crimping zones 124 of the connector 26. By having at least a portion of the mold 138 slightly smaller than the connector 26 in at least some areas, the crimping tool 24 may be used to at least partially crush, or crimp, the connector 26. It will be appreciated that some areas of the connector 26 may remain uncrimped, for example, the end sections 110 and 112 and the center section 116.

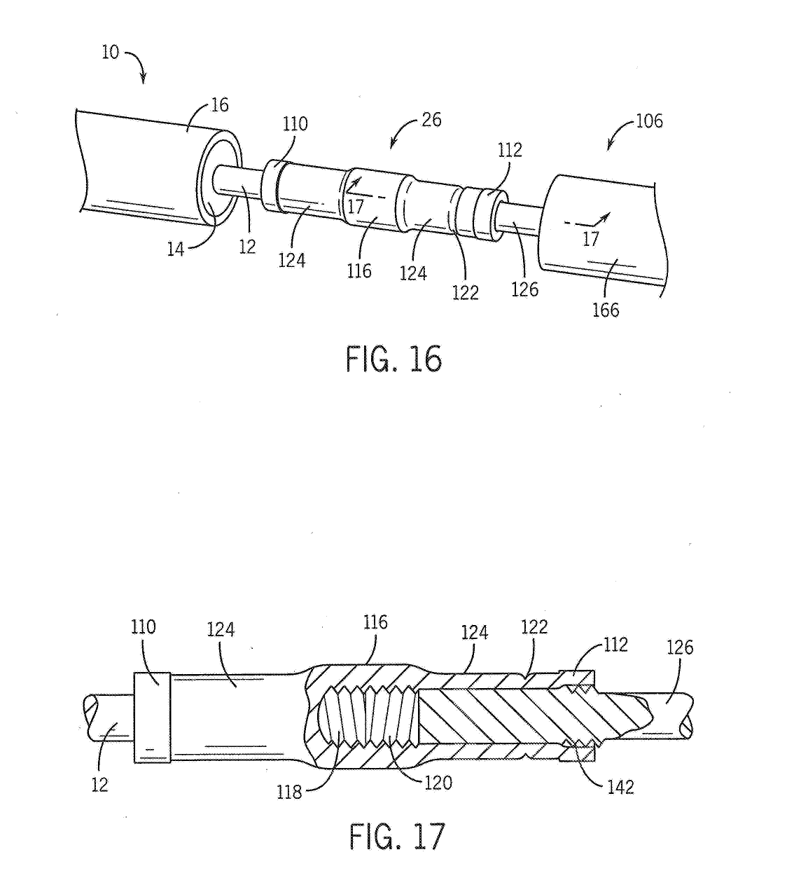

Referring to FIG. 15, to crimp the connector 26 the bottom plate 128 is placed below the cables 10 and 10b, with the connector 26 resting within the mold indentation 138 and with the crimping zones 140 of the bottom plate 128 matching up with the crimping zones 124 of the connector 26. The top plate 126 may then be placed on top of the bottom plate 128, such that the guide pins 134 slide within the bores 136. The clamping fasteners 132 may then be threaded entirely through the bores 130 and then at least partially into the bores 136. As the clamping fasteners 132 are threaded into the bores 130 and 136, the top plate 126 is pulled down towards the bottom plate 128 due to the clamping fasteners 132. As the clamping fasteners 132 are tightened, the top 126 and bottom 128 plates create a clamping force that will crush, or crimp, the connector 26, such that the connector 26 is at least partially compressed as shown in FIGS. 16 and 17. After the clamping fasteners 132 are sufficiently tightened, and the connector 26 is sufficiently crimped, the clamping fasteners 132 may be removed from the bores 130 and 136 and the top plate 126 may be separated from the bottom plate 128. As mentioned above, the crimped connector 26, as shown in FIG. 17, may significantly reduce or eliminate any gaps 142 between the threads 90 and the threads 118 and between the threads 90b and the threads 120. Subsequent to crimping, the connector 26 and the cores 12 and 12b should effectively be one indistinguishable piece, such that the cables 10 and 10b and/or the connector 26 must be cut or destroyed to decouple the cables 10 and 10b.

After the cores 12 and 12b and connector 26 have been crimped, the cables 10 and 10b may be finished. The cable may be finished in a variety of ways. For example, new insulation, a new sheath, and/or a new jacket may be applied. It will be appreciated that if a new section of jacket is a solid tube, then it may need to be slid over a section of the cable 10 prior to attaching the connector to the cores 12 and 12b to the connector 26. If the new jacket is a length of wrappable material, then it may be applied after the cores 12 and 12b are connected and crimped to the connector 26.

The method of cold splicing two lengths of cable 10 and 10b will now be described using the tools described above. A length of cable 10 may have its sheath 16 scored by a scoring tool, for example the scoring tool 18 as described above. The insulation 14 may be removed, and the core 12 may be faced using a facing tool, such as the facing tool 20. The core 12 may be threaded 90 (either using right hand threads or left hand threads) using a threading tool, such as the threading tool 22. The second cable 10b may similarly be scored, faced, and threaded (using the opposite threading as the first cable 10) using the same or similar tools (with the exception that the threading tool must be modified, or a new threading tool must be used, to create an opposite threading orientation). The cables 10 and 10b may be connected together by threading the cables 10 and 10b onto a connector 26 and then turning the connector 26. The crimping tool 24 may then be placed around the connector 26 and tightened to crimp the connector 26.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A method of cold joining a first cable with a first core and a second cable with a second core, the method including the steps of:
forming threads into the first core, the threading have a first direction;
forming threads into the second core, the threading having a second direction;
at least partially threading onto the first core a connector having a first set of threads and a second set of threads; and
at least partially threading the connector onto the second core.

2. The method of claim 1, further including the steps of:
crimping at least a portion of the connector onto the first and second cores.

3. The method of claim 1, wherein the first and second cores each have a diameter, the method further including the steps of:
using a facing tool to reduce the diameter of at least one of the first and second cores.

4. The method of claim 1, wherein the first cable has a first jacket and the second cable has a second jacket, the method further including the steps of:
using a scoring tool to score at least a portion of at least one of the first and second jackets;
removing the scored portion of the jacket of at least one of the first and second jackets.

5. The method of claim 1, wherein the first core threads are right hand threads and the second core threads are left hand threads.

6. The method of claim 5, wherein the connector has right hand threads extending axially inward from a first axial end of the connector; and wherein the connector has left hand threads extending axially inward from a second axial end of the connector.

7. The method of claim 6, wherein rotating the connector in a first direction causes both the first and the second cores to thread with the connector.

8. The method of claim 6, where threading the connector to the second core simultaneously threads the connector to the first core.

9. The method of claim 2, wherein the connector has a first crimp zone having a diameter less than the diameter of a center section of the connector.

10. The method of claim 9, wherein the connector has a second crimp zone having a diameter less than the diameter of the center section of the connector.

11. The method of claim 2, wherein prior to crimping the threads of the first core and the threads of the connector form a radially spaced gap; and
wherein after crimping the radially spaced gap is removed.

12. The method of claim 1, wherein at least one of the first and the second cores are a conductive wire.

13. The method of claim 10, wherein the crimping tool simultaneously crimps the first crimp zone and the second crimp zone.

14. A connector for cold joining two lengths of cable, the connector comprising:
a connector body having a first end section, a second end section, and a center section; and
a bore extending axially through the connector body;
wherein the bore has a first set of threads extending from the first end section towards the center section and a second set of threads extending from the second end section towards the center section; and
wherein one of the first and second set of threads has right hand threads and the other has left hand threads.

15. The connector of claim 14, wherein a portion of the connector has a first crimping zone.

16. The connector of claim of claim 13 wherein a portion of the connector has a second crimping zone; and
wherein the first crimping zone is disposed around a portion of the right hand threads, and the second crimping zone is disposed around a portion of the left hand threads.

17. The connector of claim 16, wherein the first crimping zone is located axially between the first end section and the center section and the second crimping zone is located axially between the second end section and the center section.

18. The connector of claim 17, wherein the first crimping zone has a diameter between the bore and an outer surface of the first crimping zone, the first end section has a diameter between the bore and an outer surface of the first end section, and the center section has a diameter between the bore and an outer surface of the center section; and
wherein the diameter of the first crimping zone is less than the diameter of the first end section and the diameter of the center section.

19. The connector of claim 18, where the second crimping zone has a diameter between the bore and an outer surface of the second crimping zone and the second end section has a diameter between the bore and an outer surface of the second end section; and
wherein the diameter of the second crimping zone is less than the diameter of the second end section and the diameter of the center section.

20. The connector of claim 14, wherein the bore has a first diameter for the first set of threads and a second diameter for the second set of threads, the first and second diameters being different.
